(19) United States
(12) Patent Application Publication
(10) Pub. No.: US 2026/0200316 A1
(43) Pub. Date: Jul. 16, 2026

(54) ELECTRONIC THROTTLE CONTROL PEDAL ASSEMBLY

(71) Applicant: KSR IP Holdings, LLC, Wilmington, DE (US)

(72) Inventor: Wjatscheslaw Kauz, Pattensen (DE)

(73) Assignee: KSR IP Holdings, LLC, Wilmington, DE (US)

(21) Appl. No.: 19/445,776

(22) Filed: Jan. 12, 2026

Related U.S. Application Data
(60) Provisional application No. 63/744,550, filed on Jan. 13, 2025.

(51) Int. Cl. B60K 26/02

(52) U.S. Cl. CPC B60K 26/02

(57) ABSTRACT

Embodiments herein are directed to a pedal assembly that includes a housing with an opening, a pedal arm, and a resilient member. The pedal arm has a receiving void positioned between the hub portion and the pedal pad portion. The resilient member is positioned at least partially within the receiving void and has a distal portion and a proximate portion. The distal portion overlaps the proximate portion by an overlap length. The resilient member is movable between a home position and a use position. When a predetermined load is applied to the pedal arm, the resilient member is moved into the use position such that the overlap length of the distal portion with respect to the proximate portion is greater that the overlap length of the distal portion with respect to the proximate portion in the home position to generate a force feedback onto the pedal arm.

### CROSS-REFERENCE TO RELATED APPLICATIONS

This utility patent application claims priority benefit from U.S. Provisional Patent Application Ser. No. 63/744,550, filed Jan. 13, 2025, and entitled “Electronic Throttle Control Pedal Assembly”, the entire contents of which is incorporated herein by reference in its entirety.

### TECHNICAL FIELD

The present specification generally relates to pedal assemblies for vehicles and, more specifically, to pedal assemblies with a mechanical resistance with hysteresis.

### BACKGROUND

Electronic throttle controlled (ETC) pedal assemblies are well known. In ETC pedal assemblies, an accelerator pedal is coupled or in communication with a throttle, replacing mechanical linkage. Generally, ETC pedal assemblies include an accelerator pedal module, a throttle valve that can be opened and closed by an electric motor, and a powertrain or engine control module that employs software to determine the required throttle position by calculations from data measured by other sensors. Further, conventional ETC pedal assemblies include a mechanical kick-down device such that a driver can feel the kick-down by an increased force required to actuate the pedal. However, conventional mechanical kick-down devices include many components, which make them more complicated and expensive, require additional tooling for manufacturing, and have a double click effect due to multiple surfaces of the kick-device housing engaging with a pedal housing and/or pedal arm.

Accordingly, a need exist for a kick-down device that is simpler, less expensive, requires less tooling and costs of manufacturing, and eliminates the double click effect.

### SUMMARY

In one embodiment, a pedal assembly is provided. The pedal assembly includes a housing having an opening, a pedal arm, and a resilient member. The pedal arm has a hub portion at one end positioned within the opening of the housing and a pedal pad portion positioned on an opposite end of the pedal arm. The hub portion is movably coupled to the housing. The pedal arm further has a receiving void positioned between the hub portion and the pedal pad portion. The resilient member is positioned at least partially within the receiving void and has a distal portion and a proximate portion. The distal portion overlaps the proximate portion by an overlap length. The resilient member is movable between a home position and a use position. When a predetermined load is applied to the pedal pad portion, the resilient member is moved into the use position such that the overlap length of the distal portion with respect to the proximate portion is greater that the overlap length of the distal portion with respect to the proximate portion in the home position to generate a force feedback onto the pedal pad portion.

In another embodiment, a pedal assembly is provided. The pedal assembly includes a housing having an opening, a pedal arm, a bearing member, a carrier, at least one compressible member, and a resilient member. The pedal arm has a hub portion at one end positioned within the opening of the housing and a pedal pad portion positioned on an opposite end of the pedal arm. The hub portion includes a pair of flanges and a receiving void positioned between the hub portion and the pedal pad portion. The bearing member has an interior surface, an opposite exterior surface, a pair of receiving grooves, and at least one resilient member extending from the exterior surface. The pair of receiving grooves are positioned to complement the pair of flanges such that the bearing member is positioned to couple to the hub portion via a slidably engagement between the pair of flanges and the pair of receiving grooves. The at least one resilient member is configured to engage with a portion of the housing to movably couple the hub portion of the pedal arm to the housing. The carrier is coupled to and received within the opening of the housing to enclose a portion of the opening. The at least one compressible member is positioned extend between and to be in contact with the pedal arm and the carrier. The resilient member is positioned at least partially within the receiving void. The resilient member has a distal portion and a proximate portion. The distal portion overlaps the proximate portion by an overlap length. The resilient member is movable between a home position and a use position. When a predetermined load is applied to the pedal pad portion, the resilient member is moved into the use position such that the overlap length of the distal portion with respect to the proximate portion is greater that the overlap length of the distal portion with respect to the proximate portion in the home position and the at least one compressible member is compressed to provide an increased force to the pedal arm generating additional force between the hub portion and the interior surface of the bearing member thereby together generating a force feedback onto the pedal pad portion.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective side view of an example electronic throttle pedal assembly according to one or more embodiments shown and described herein;

FIG. 2 schematically depicts an exploded perspective view of the example electronic throttle pedal assembly of FIG. 1 according to one or more embodiments shown and described herein;

FIG. 3A schematically depicts an isolated perspective view of a resilient member of the example electronic throttle pedal assembly of FIG. 2 according to one or more embodiments shown and described herein;

FIG. 3B schematically depicts an isolated side view of the resilient member of the example electronic throttle pedal assembly of FIG. 3 and a receiving void of a pedal arm of the example electronic throttle pedal assembly of FIG. 2 according to one or more embodiments shown and described herein;

FIG. 3C schematically depicts an partial perspective view of the resilient member of the example electronic throttle pedal assembly positioned within the receiving void of the pedal arm of FIG. 3B according to one or more embodiments shown and described herein;

FIG. 3D schematically depicts an isolated side view of the resilient member positioned within the receiving void of the pedal arm of FIG. 3B illustrating the resilient member in a home position in solid line and in a use position in a dashed-dot line according to one or more embodiments shown and described herein;

FIG. 3E schematically depicts an isolated side view of the resilient member in the use position within the receiving void of the pedal arm of FIG. 3D according to one or more embodiments shown and described herein;

FIG. 4 schematically depicts a graphical representation of a kickdown force curve with a desired force illustrated as a dotted line according to one or more embodiments shown and described herein;

FIG. 5A schematically depicts an isolated exploded perspective view of a first aspect of a pedal arm assembly of the example electronic throttle pedal assembly of FIG. 1 according to one or more embodiments shown and described herein;

FIG. 5B schematically depicts an isolated partial perspective view of a bearing member aligning with a hub portion of the pedal arm of the pedal arm assembly of FIG. 5A according to one or more embodiments shown and described herein;

FIG. 5C schematically depicts an isolated partial perspective view of the bearing member rotated to lock into the hub portion of the pedal arm of the pedal arm assembly of FIG. 5A according to one or more embodiments shown and described herein;

FIG. 6 schematically depicts a partial exploded perspective view of the example electronic throttle pedal assembly of FIG. 1 illustrating a housing, a pedal arm assembly, a carrier, and a compressible member in an unassembled state according to one or more embodiments shown and described herein;

FIG. 7 schematically depicts a partial exploded perspective view of the example electronic throttle pedal assembly of FIG. 6 illustrating an assembly of the pedal arm assembly into the housing according to one or more embodiments shown and described herein;

FIG. 8 schematically depicts a perspective view of the example electronic throttle pedal assembly of FIG. 7 illustrating the pedal arm assembly assembled and coupled into the housing according to one or more embodiments shown and described herein;

FIG. 9 schematically depicts a perspective view of the example electronic throttle pedal assembly of FIG. 6 illustrated in an assembled state with the pedal arm assembly assembled into the housing, the carrier assembled into the housing, and the compressible member positioned between the pedal arm assembly and the carrier according to one or more embodiments shown and described herein;

FIG. 10 schematically depicts a partial cross section view taken from line 10-10 in FIG. 9 with the example electronic throttle pedal assembly in the assembled state and with a predetermined amount of load applied to the pedal arm such that the resilient member is in the use position according to one or more embodiments shown and described herein;

FIG. 11A schematically depicts a partial perspective view of a second example electronic throttle pedal assembly illustrating a second aspect carrier and pedal arm assembly according to one or more embodiments shown and described herein;

FIG. 11B schematically depicts an exploded perspective view of the second example electronic throttle pedal assembly of FIG. 11A according to one or more embodiments shown and described herein;

FIG. 12A schematically depicts an isolated perspective view of a third example carrier according to one or more embodiments shown and described herein;

FIG. 12B schematically depicts an isolated perspective view of a third example carrier according to one or more embodiments shown and described herein; and

FIG. 13 schematically depicts an isolated perspective view of a second aspect of the compressible member of FIG. 6 according to one or more embodiments shown and described herein.

### DETAILED DESCRIPTION

Embodiments described herein are directed to an electronic throttle control (ETC) pedal assembly configured to provide a kick-down feeling to a driver's foot by utilizing a resilient member that is simpler, less expensive, requires less tooling and costs of manufacturing, and eliminates the double click effect compared to conventional kick-down devices. The resilient member is at least partially received in a receiving void of a pedal arm and is configured to engage with portions of the receiving void and with portions of a housing of the pedal assembly based on an amount of a load applied to a pedal pad portion of the pedal arm.

The resilient member may be include a distal portion and a proximate portion in which the distal portion overlaps the proximate portion by an overlap length. The resilient member is movable or deformable between a home position and a use position such that when the predetermined load is applied to the pedal pad portion, the resilient member is moved into the use position causing the overlap length of the distal portion with respect to the proximate portion to be greater than the overlap length of the distal portion with respect to the proximate portion in the home position, thus generating a force feedback onto the pedal pad portion. The engagement of the resilient member with portions of the receiving void and/or with portions of the housing is configured in such a way that when the resilient member deforms or moves, the movement of the distal portion with respect to the proximate portion can be tuned to a specific force feedback applied onto the pedal pad portion and felt by the diver dependent on a relationship relative to the amount of load applied to the pedal pad portion.

The ETC pedal assembly may further include a bearing member and a spring carrier that has a compressible member extending between the spring carrier and the pedal arm. The spring carrier may be partially received into and coupled to the housing. The bearing member may slidably engage with the hub portion and movably couple the pedal arm to the housing. When the predetermined load is applied to the pedal pad portion, the at least one compressible member is compressed to provide an increased force to the pedal arm generating additional force between the hub portion and an interior surface of the bearing member thereby generating an additional force feedback onto the pedal pad portion.

Various embodiments of the ETC assembly and methods for assembly thereof are described in detail herein.

As used herein, the term “communicatively coupled” means that coupled components are capable of exchanging data signals with one another such as, for example, electrical signals via conductive medium or a non-conductive medium, though networks such as via Wi-Fi, Bluetooth, and the like, electromagnetic signals via air, optical signals via optical waveguides, and the like.

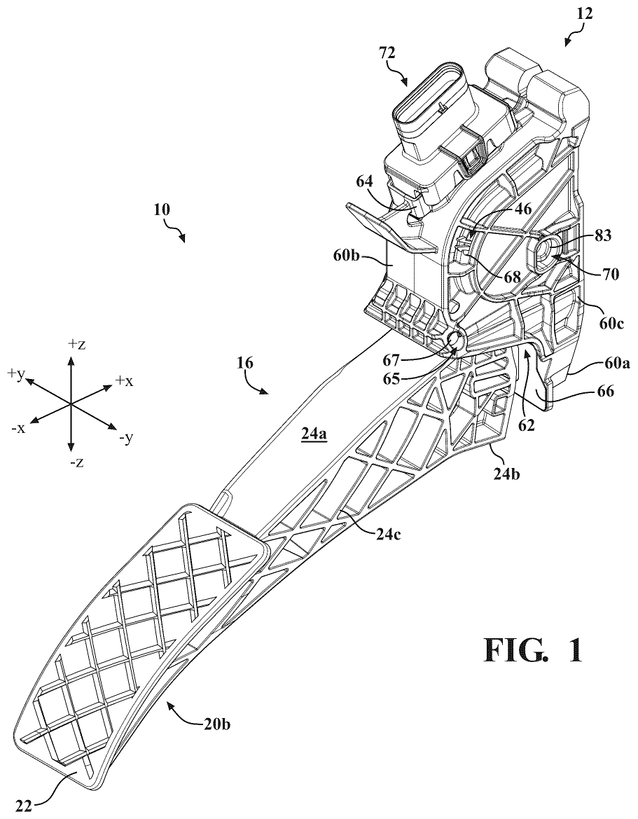

As used herein, the term “lateral direction” refers to the cross-direction of the pedal assembly (i.e., in a +/−Y direction of the coordinate axes depicted in FIG. 1). The term “longitudinal direction” refers to the forward-rearward direction of the pedal assembly (i.e., along the +/−X axis of the coordinate axes depicted in FIG. 1), and is transverse to the lateral direction. The term “vertical direction” refers to the upward-downward direction of the pedal assembly (i.e., in the +/−Z direction of the coordinate axes depicted in FIG. 1).

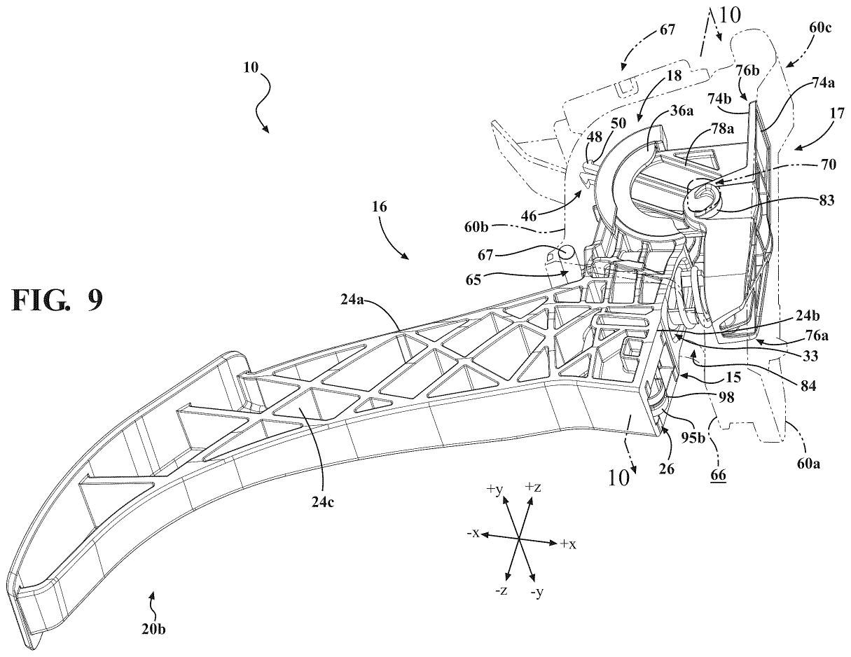

Referring initially to FIGS. 1-2 and 5A-10, an example electronic throttle control (ETC) pedal assembly 10 is schematically depicted. The ETC pedal assembly 10 includes a housing 12, a pedal arm assembly 14, a resilient member 15, a carrier 17, and a sensor assembly 19. The pedal arm assembly 14 includes a pedal arm 16 and a bearing member 18. The pedal arm 16 has a hub portion 20a at a proximate end of the pedal arm 16, and an opposite pedal pad portion 20b, positioned at the distal end of the pedal arm 16. The bearing member 18 is configured to slidably engage with the hub portion 20a and to couple the pedal arm 16 to the housing 12, as discussed in greater detail herein. As such, the hub portion 20a is pivotally or movably mounted or coupled to the housing 12.

A pedal pad 22 is positioned at the pedal pad portion 20b. The pedal pad 22 and the pedal pad portion 20b receive a load applied by a driver such that the pedal arm 16 pivots, moves, and/or rotates with respect to the housing 12 based on an amount of the load applied to the pedal pad 22 and the pedal pad portion 20b.

The pedal arm 16 includes an interior surface 24b spaced apart from an exterior surface 24a by a wall 24c to define the spacing between the interior surface 24b and the exterior surface 24a. Further, the pedal arm 16 may include a receiving void 26 positioned between the hub portion 20a and the pedal pad portion 20b. The receiving void 26 is cavity opening to the interior surface 24b of the pedal arm 16 and the wall 24c towards the interior surface 24b. The receiving void 26 may be defined by an interior surface 28. The interior surface 28 of the receiving void 26 may include one or more protrusions 30 and may have an irregular shape configured to allow the resilient member 15 to deform and/or move in a predetermined pattern. In some embodiments, the one or more protrusions 30 may have a ramped or sloped surface in one direction to create a step to interact or otherwise engage with the resilient member 15 based on the amount of load applied onto the resilient member 15, and a different shape in the return direction of the one or more protrusions 30, as discussed in greater detail herein. The size and shape of the one or more protrusions 30 and the interior surface 28 may be determined to tune a kickdown force profile (e.g., a force feedback felt by the driver at the pedal pad portion 20b of the pedal arm 16). That is, as discussed in greater detail herein, the resilient member 15, the shape of the interior surface 28, and/or the one or more protrusions 30 may be customized to tune the example ETC pedal assembly 10 to provide a desired kickdown force profile illustrated in FIG. 4.

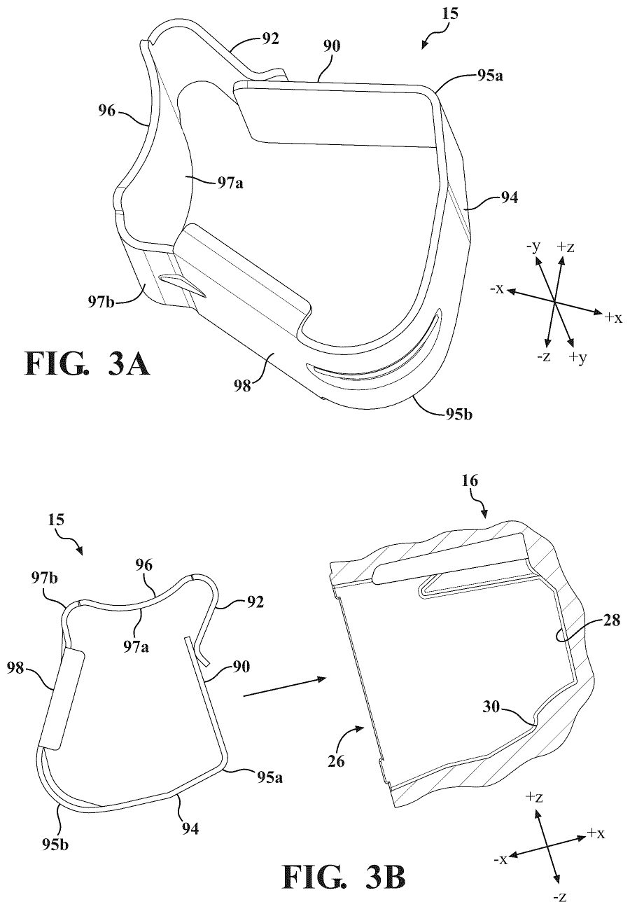

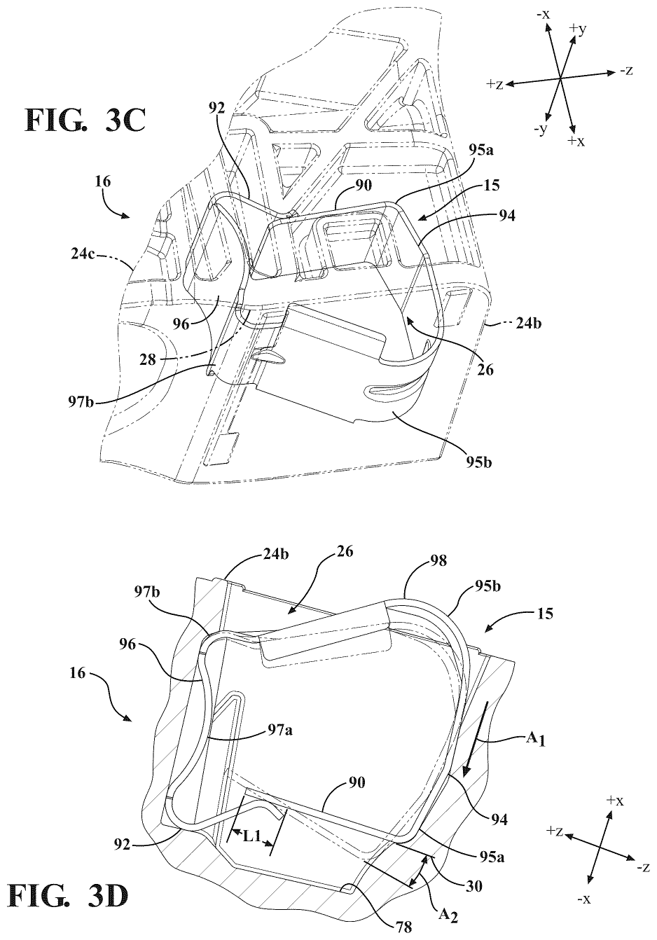

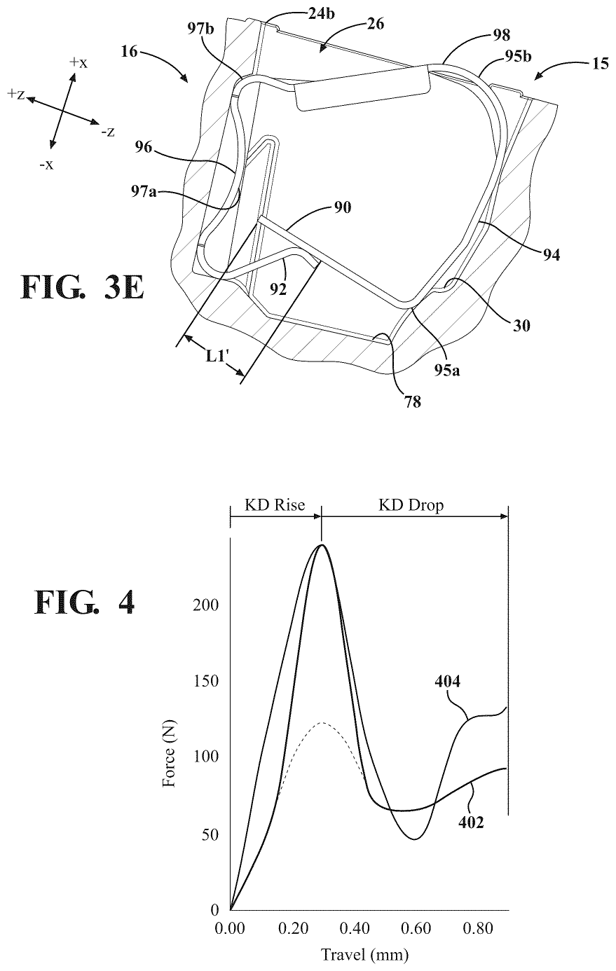

As such, in other embodiments, the one or more protrusions 30 may be sloped in the directions towards the rear of the receiving void 26 (e.g. in the direction from the interior surface 24b to the 24a of the pedal arm 16) at a steep slope (e.g., acute angle), gradually sloped (e.g., oblique angle), in a uniform slope, in a non-uniform slope, in a convex shape such that the slope is steeper at the bottom and gradually becoming less steep toward the top, in a concave slope such that the slope starts gentle at the bottom and becomes steeper further up, and/or the like. The one or more protrusions 30 may be slope at such an angle or degrees to require a predetermined amount of load to be applied to the resilient member 15 to cause the resilient member 15 to move or travel beyond the one or more protrusions 30 within the receiving void 26 in the direction of travel indicated by the arrow A1, as best illustrated in FIG. 3D, and as further described in greater detail herein. Further, there may be less or different sloped surface on the other side of the at least one protrusion 30 (e.g., on the portion closer to the rear of the receiving cavity-closer to the exterior surface 24a of the pedal arm 16).

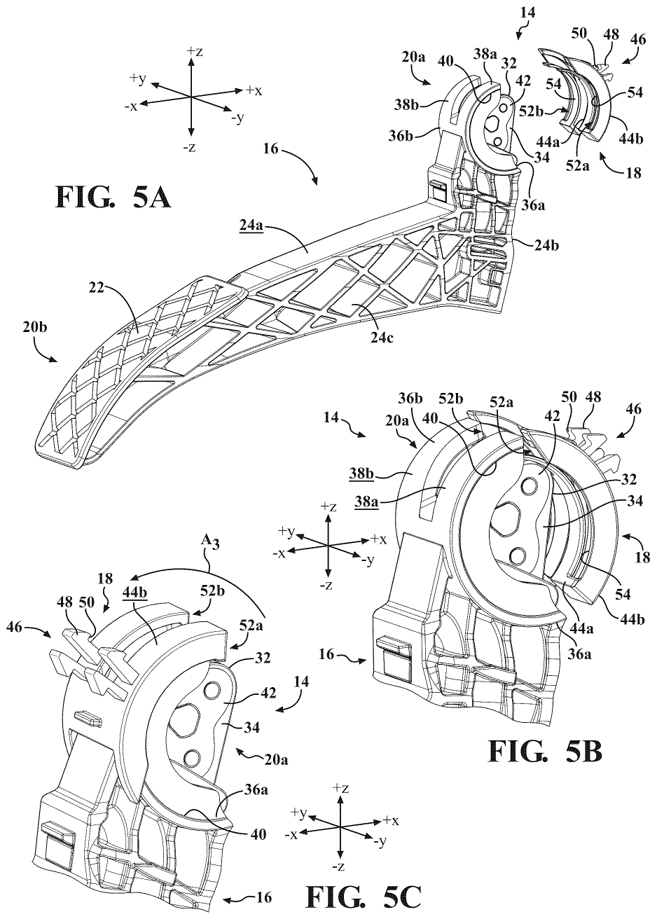

The amount of movement or travelling of the resilient member 15 and/or deformation within the receiving void 26 may also be customized by the shape of the interior surface 28. That is the interior surface 28 may be configured to maintain a position of portions of the resilient member 15 while permitting other portions of the resilient member 15 to move and/or deform in the predetermined pattern to achieve the desired and where the kickdown force profile, illustrated in FIG. 5 and as discussed in greater detail herein.

In some aspects, the pedal arm 16 may further include a compressible member receiving cavity 33. The compressible member receiving cavity 33 may be positioned between the hub portion 20a and the receiving void 26 in the vertical direction (i.e., in the +/−Z direction). The compressible member receiving cavity 33 may be defined by an interior surface 35. The interior surface 35 of the compressible member receiving cavity 33 may include a compressible member protrusion 37 configured to retain an end of at least one compressible member 84, as discussed in greater detail herein.

The hub portion 20a may be formed by the interior surface 24b and the exterior surface 24a of the pedal arm joining at a radius 32 that has a predetermined generally arc shape. The predetermined generally arc shape may be a connecting curve that may be arcuate in shape, semicircular in shape, a regular shape, an irregular shape, and/or the like. The hub portion 20a may also include a pair of side surfaces 34 that are spaced apart. At least one of the pair of side surfaces 34 may be configured to receive or otherwise have a coupler 42 attached thereon, as discussed in greater detail herein. That is, in some embodiments, the at least one of the pair of side surfaces 34 may include a cutout or stepped portion that follows an outer circumference of the coupler 42 to receive the coupler 42. The coupler may be heat staked into position on the at least one of the pair of side surfaces 34.

A pair of flanges 36a, 36b extend from the portions of the hub portion 20a. For example, and without limitation, in some embodiments, from portions of the radius 32 that has the predetermined generally arc shape. In other embodiments, from portions of the interior surface 24b, the exterior surface 24a, and/or the wall 24c. In other embodiments, from a combination of portions of the interior surface 24b, the exterior surface 24a, and/or the wall 24c and from portions of the radius 32 that has the predetermined generally arc shape.

Each of the pair of flanges 36a, 36b are acuate in shape and include a flange surface 38a, 38b, respectively. The flange surface 38a, 38b have a smooth contour and are configured as a bearing surface to slidably engage with the bearing member 18, as discussed in greater detail herein. As such, the each of the pair of flanges 36a, 36b may have a lip 40 or other retaining feature to engage with and retain the bearing member 18, as discussed in greater detail herein.

The bearing member 18 includes an interior surface 44a and an opposite exterior surface 44b that are generally arcuate in shape. That is, the bearing member 18 is generally the same or complementary shape to at least the flange surface 38a, 38b of the pair of flanges 36a, 36b. At least one resilient member 46 extends from the exterior surface 44b of the bearing member 18. In some embodiments, the at least one resilient member 46 may be a locking tang 48 with a tab 50 at a distal end that is configured to engage with the housing 12, as discussed in greater detail herein. In other embodiments, the at least one resilient member 46 may be a fastener, hook and loop, and/or the like that is configured to couple the bearing member 18 to the housing 12, as discussed in greater detail herein.

The interior surface 44a of the bearing member 18 includes a pair of receiving grooves 52a, 52b. The pair of receiving grooves 52a, 52b are spaced apart a similar distance to the pair of flanges 36a, 36b such that at least portions of the respective one of the pair of flanges 36a, 36b are received in the respective one of the pair of receiving grooves 52a, 52b and such that the flange surface 38a, 38b of the pair of flanges 36a, 36b slidable engage with an inner surface 54 of each of the pair of receiving grooves 52a, 52b thereby forming a bearing surface in the bearing member 18. That is, the flange surface 38a, 38b of each of the pair of flanges 36a, 36b are configured to form a bearing surface with the inner surface 54 of each of the pair of receiving grooves 52a, 52b and the respective such that, based on the load applied to the pedal arm, the pair of flanges 36a, 36b of the hub portion 20a move within and against at least portions of the inner surface 54 of each of the pair of receiving grooves 52a, 52b, thereby generating a force feedback onto the pedal pad portion 20b.

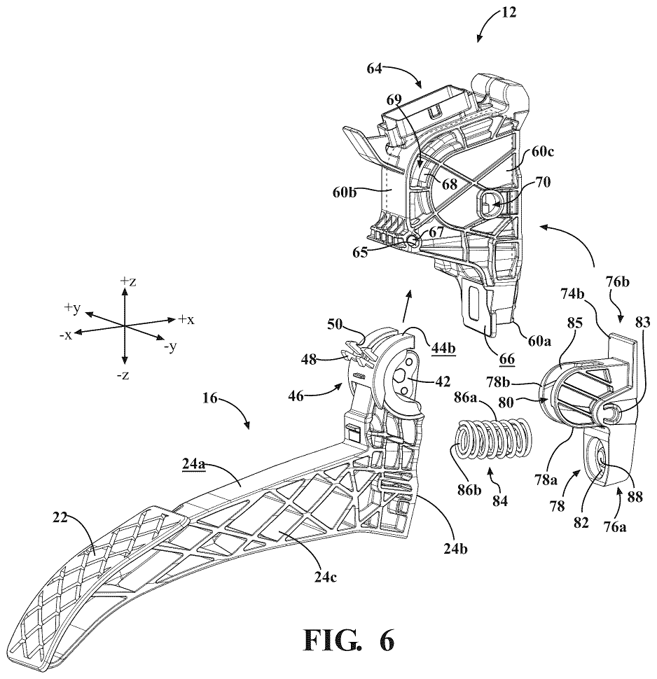

The bearing member 18 is coupled onto the hub portion 20a and retained thereon by aligning the pair of receiving grooves 52a, 52b of the bearing member 18 with the pair of flanges 36a, 36b of the hub portion 20a, as best illustrated in FIG. 3 and rotating the bearing member 18 onto the pair of flanges 36a, 36b such that the lip 40 is retained within the pair of receiving grooves 52a, 52b in the direction indicated by the arrow A3 depicted in FIG. 6C. As such, pedal arm 16 is movably coupled to the bearing member 18, which in turn is coupled to the housing 12, as discussed in greater detail herein. Because the pedal arm 16 is only permitted a predetermined amount of travel or arc, the hub portion 20a cannot disengage from the bearing member 18 while the bearing member 18 is coupled to the housing 12. Therefore, such an arrangement permits for an easy assembly of the pedal arm 16 to the housing 12.

The housing 12 includes a back wall 60a and an opposite front wall 60b and a pair of sidewalls 60c. Further, the housing 12 may include an opening 62 or aperture that may extend from the front wall 60b to the back wall 60a. The opening 62 or aperture may be any size and shape. In the depicted embodiment, the opening 62 or aperture is larger in the rear than in the front of the housing 12 to receive the pedal arm 16 in the front and the carrier 17 in the rear, as discussed in greater detail herein. Portions of the back wall 60a may include an engagement surface 66 that is configured to engage with portions of the resilient member 15 when a predetermined amount of load is applied to the pedal pad portion. The housing 12 further includes at least one slot 68 that is configured to receive and retain the locking tang 48 with the tab 50 for each of the at least one resilient member 46 of the bearing member 18. Further, the housing 12 may include a window 69, cutout, void, or the like, that allows for visual inspection that the locking tang 48 with the tab 50 for each of the at least one resilient member 46 of the bearing member 18 is properly positioned and locked to the at least one slot 68.

Each of the sidewalls 60c may include a receiving aperture 70 that is configured to movable couple the carrier 17 to the housing 12, as discussed in greater detail herein. That is, each receiving aperture 70 may in communication with the opening 62 to provide access to the spring carrier when positioned within the opening 62 of the housing 12, as discussed in greater detail herein. The depicted embodiment, the receiving aperture 70 is depicted as half-moon shaped. This is non-limiting and the receiving aperture 70 may be any shape including, without limitation, elliptical, circular, square, hexagonal, irregularly shaped, and/or the like.

The housing 12 further includes a connector opening 64 and an elongated aperture 65 extending between the pair of sidewalls 60c. The connector opening 64 includes a mounting portion for a connector assembly 72 of the sensor assembly 19, as discussed in greater detail herein. The connector opening 64 provides access to the opening 62 such that components of the example ETC pedal assembly 10, such as at least components of the sensor assembly 19, may be positioned within the opening 62 and exit or extend from the housing 12 via the connector opening 64, as discussed in greater detail herein.

The elongated aperture 65 is configured to receive an up-stop damper 67. The up-stop damper 67 is configured interact or otherwise engage with the pedal arm 16 to control an amount of travel of the pedal arm 16 in the direction opposite of the load applied to the pedal pad portion 20b. That is, the up-stop damper 67 is configured to set a predetermined return distance to a home or idle position for the pedal arm 16.

The housing 12 may be mounted to a dash of a vehicle such as to an instrument panel, a firewall and/or the like. As such, the back wall 60a is coupled, mounted or otherwise attached to a component of the vehicle to hold the pedal pad portion 20b and the pedal pad away from a vehicle floor in a vertical direction (i.e., in the +/−Z direction).

In the depicted aspect, the carrier 17 has an outer surface 74a and an opposite inner surface 74b that define a thickness. Further, the carrier 17 includes a front portion 76a and an opposite rear portion 76b. A compressible member receiving portion 78 is positioned within the front portion 76a and extending into the inner surface 74b.

The compressible member receiving portion 78 is depressed or recessed within the inner surface 74b. The compressible member receiving portion 78 includes a compressible member receiving surface 82 adapted to receive an end of the at least one compressible member 84, depicted as an outer compressible member 86a, such as a spring, an inner compressible member 86b, such as a spring received within an inner diameter of the outer compressible member 86a, and a damper 86c. In some embodiments, the at least one compressible member 84 may be formed with a steel material. In other embodiments, the at least one compressible member 84 may be formed with stainless steel, wire, carbon steel, alloy steel, elgiloy, Monel®, copper, nickel, and/or the like. This is not limiting and the at least one compressible member 84 may be any deformable material or design, such as elastomer. The compressible member receiving surface 82 includes a generally circular holding portion and a central protrusion 88 to retain the end of the at least one compressible member 84.

The at least one compressible member 84 is configured to extend between and to be received within the compressible member receiving surface 82 of the carrier 17 and the compressible member receiving cavity 33 of the pedal arm 16. As discussed in greater detail herein, the at least one compressible member 84 assist in providing additional force feedback (e.g., hysteresis) onto the pedal pad portion 20b based on the amount of load applied to the pedal pad portion 20b by the driver.

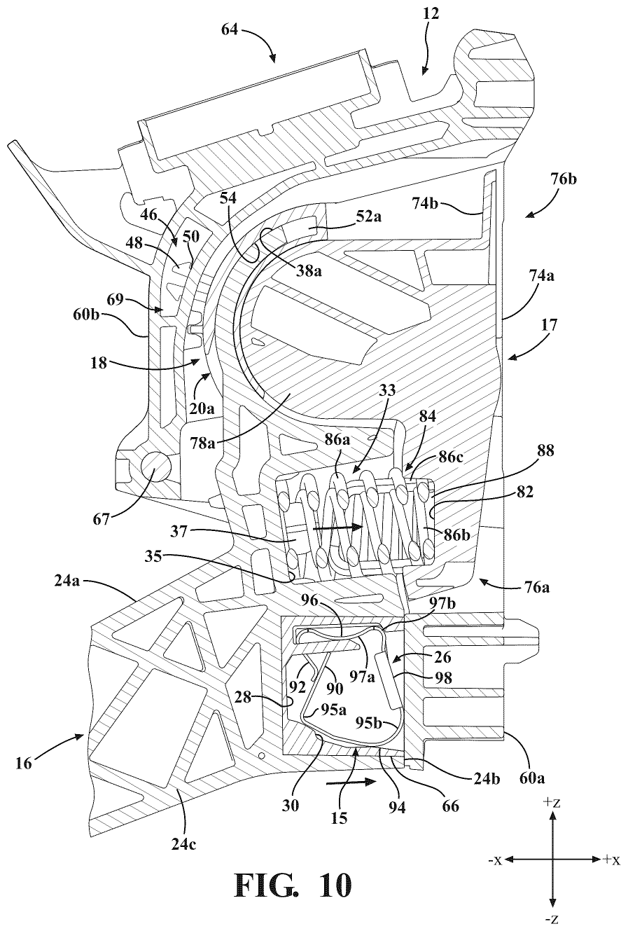

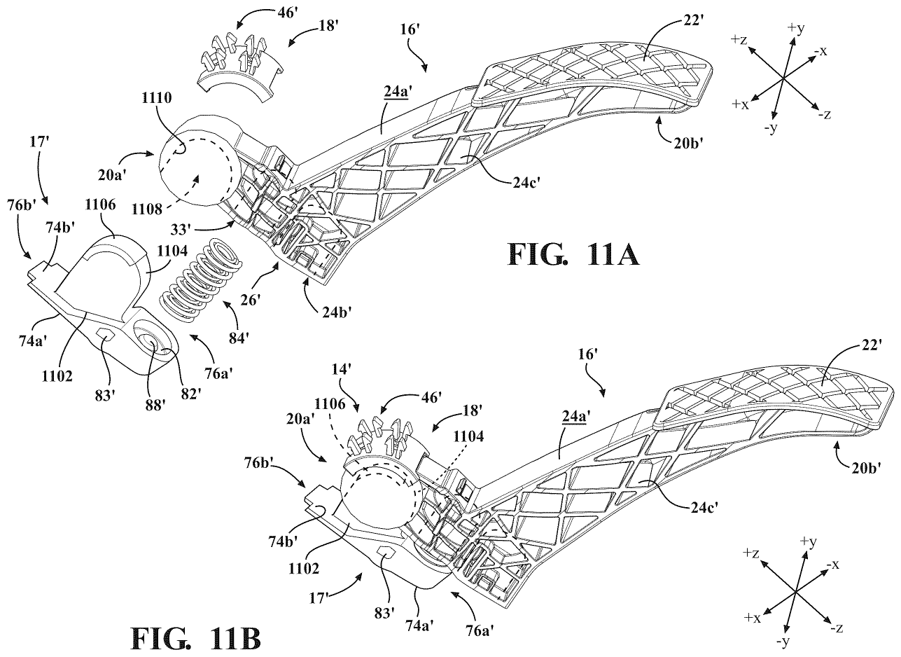

As depicted, a pair of spaced apart ears 78a, 78b extend from the inner surface 74b and at the rear portion 76b to define a gap 80 between a respective interior surface 85. The gap 80 is a predetermined width based on the width of the hub portion 20a of the pedal arm 16. As such, in the assembled state, as best illustrated in FIGS. 10 and 11, portions of the hub portion 20a are received within the gap 80. The carrier 17 further includes a pair of protrusions 83 extending from the thickness in the lateral direction (i.e., in the +/−Y direction) positioned between the front portion 76a and the rear portion 76b. The pair of protrusions 83 are sized and shaped to be received by the receiving aperture 70 of the housing 12. The pair of protrusions 83 are configured to movably couple the carrier 17 to the housing 12 within the opening 62 in the assembled state. Further, in the assembled state, when the pair of protrusions 83 are received within the corresponding receiving aperture 70 of the housing 12, the outer surface 74a forms the remaining portion the back wall 60a of the housing 12 (e.g., encloses the opening 62 of the back wall 60a of the housing 12). In the assembled state, the carrier 17 is configured to move within the opening 62 based on the load applied to the pedal pad portion 20b of the pedal arm 16.

In some embodiments, the housing 12, the pedal arm 16, the carrier 17, and/or the bearing member 18 may be formed with various materials such as acrylonitrile butadiene styrene (ABS), polyethylene (PE), polypropylene (PP), polycarbonate (PC), polyamide thermoplastic (PA)—known as nylon- and variations of nylon including PA6 and PA66, Polyphthalamide (PPA), polycarbonate/acrylonitrile butadiene styrene, polyurethane, polymethyl methacrylate, high density polyethylene, low density polyethylene, polystyrene, PEEK, POM (Acetal/Delrin), polyethylene terephthalate, thermoplastic elastomer, polyetherimide, theremoplastic vulcanizate, polysulfone, and/or the like, and combinations thereof. Additionally, additives may be added such as UV absorbers, flame retardants, colorants, glass fibers, plasticizers, carbon fiber, aramid fiber, glass bead, PTFE, PFPE, TALC, MoS2 (Molybdenum Disulfide), graphite, and/or the like.

It should be understood that the housing 12, the pedal arm 16, the carrier 17, and/or the bearing member 18 may be all formed with the same material or may be formed with a different material or combinations of different materials. For example, in some embodiments, both the housing 12 and the pedal arm 16 may be formed with the acrylonitrile butadiene styrene material and the carrier 17 and the bearing member 18 are formed from a different material. In other embodiments, the housing 12 may be formed with acrylonitrile butadiene styrene material and the pedal arm 16 may be formed with the polyethylene material. In another embodiment, the housing 12 may be formed with acrylonitrile butadiene styrene material and nylon while the pedal arm 16 and the bearing member 18 may each be formed with acrylonitrile butadiene styrene material and a thermoplastic elastomer and the carrier 17 is formed form PEEK.

Further, in some embodiments, the housing 12, the pedal arm 16, the carrier 17, and/or the bearing member 18 may be formed from additive manufacturing techniques. Additive manufacturing techniques refer generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes. In other embodiments, the housing 12, the pedal arm 16, and/or the bearing member 18 may be formed via injection molding techniques or other known techniques

In operation, when the predetermined load is applied to the pedal pad portion 20b (indicated by the arrows depicted in FIG. 10), the at least one compressible member 84 and the pair of spaced apart ears 78a, 78b may provide an increased force to the pedal arm 16 by generating additional force between the hub portion 20a and the inner surface 54 of the bearing member 18 thereby generating the additional force feedback onto the pedal pad portion 20b felt by the driver. Because the carrier 17 is movably mounted with respect to the housing 12, when the predetermined load is applied to the pedal pad portion 20b, the at least compressible member 84 displaces the carrier 17 such that a portion of the carrier 17 leverages against the housing 12 to load the pedal arm 16 as the pedal arm 16 moves and continues to transfer the load into the pivot of the pedal arm 16 the more compression there is by the at least one compressible member (e.g., greater load applied onto the pedal pad portion 20b). This causes increased friction between the hub portion 20a and the inner surface 54 of the bearing member 18 to generate hysteresis based on the load applied to the pedal pad portion 20b.

Now referring to FIGS. 3A-3E and 10, the resilient member 15 will be further described. The resilient member 15 includes a distal portion 90 and a proximate portion 92. The distal portion 90 overlaps the proximate portion 92 by an overlap length depicted as L1. The resilient member 15 may further include a first intermediate portion 94 extending from the distal portion 90, a second intermediate portion 96 extending from the proximate portion 92 and a third intermediate portion 98 positioned between and extending from the first intermediate portion 94 and the second intermediate portion 96.

The first intermediate portion 94 may be defined by pair of acute angle portions 95a, 95b. One of the pair of acute angle portions 95a may be in communication with the distal portion 90 while the other one of the pair of acute angle portions 95b may be in communication with the third intermediate portion 98. In some aspects, the one of the pair of acute angle portions 95a in communication with the distal portion 90 has a greater angle (e.g., closer to 90 degrees) than the other one of the pair of acute angle portions 95b that in communication with the third intermediate portion 98.

In some aspects, the second intermediate portion 96 may be defined by a concave portion 97a and an acute angle portion 97b. The concave portion 97a may be in communication with the proximate portion 92 and the acute angle portion 97b while the acute angle portion 97b may be in communication with the third intermediate portion 98.

The resilient member 15 is configured to be movable between a home position, as best illustrated in FIG. 3D and a use position, as best illustrated in FIG. 3E. It should be understood that the resilient member 15 may be deformed or movable into a plurality of positions and shapes between the home position and the use position in which the home position is the extreme in one range when the pedal arm is in an idle position (e.g., no load applied to the pedal pad portion 20b) to the use position at the other extreme range (e.g., a full load applied to the pedal pad portion 20b). In the home position, the overlap length L1, as depicted in FIG. 3D, is a less distance than the overlap length L1′ in the use position, as depicted in FIG. 3E. Said another way, in the use position, the distal portion 90 is moved to be at a closer distance to the second intermediate portion 96 compared to the home position where the distal portion 90 is at a greater distance from the second intermediate portion 96.

The resilient member 15 is moved between the home position and the use position based on contact with the housing 12 and the geometry of the interior surface 28 of the receiving void 26 of the pedal arm 16. That is, in some aspects, a portion of the first intermediate portion 94 and/or a portion of the third intermediate portion 98 is/are configured to engage with the engagement surface 66 of the housing 12 based on an amount of the predetermined load applied to the pedal pad portion 20b. For example, and without limitation, at least portions of the acute angle portion 95b and/or portions of the third intermediate portion 98 extend beyond the exterior surface 24a of the pedal arm 16 to abut, make contact, or otherwise engage with the engagement surface 66 of the housing 12 based on the amount of the predetermined load applied to the pedal pad portion 20b.

This engagement causes at least the acute angle portion 95a of the first intermediate portion 94 to slidably engage with or otherwise slidably contact the protrusion 30 of the interior surface 28 of the receiving void and after exceeding a predetermined threshold amount of force, moving or displacing at least the distal portion 90 while also permitting for the resilient member to deform, displace, or move within the receiving void 26. This movement changes the position of the resilient member 15 within the receiving void 26 along with the overlap length to the overlap length L1′ best depicted in FIG. 3E.

Said another way, exceeding the predetermined threshold force allows for movement of the resilient member 15 within the receiving void 26 and this movement changes the properties of the resilient member 15 by using the interior surface 28 and/or the protrusion 30 as a cam to manipulate the shape of the resilient member 15 to generate force feedback onto the pedal pad portion (and/or assist in generating the desired kickdown force curve as illustrated in FIG. 4) based on the amount of force and travel of the pedal pad portion 20b.

The predetermined threshold force may be a pick force necessary to move or deform the resilient member 15 to allow for passage beyond the ramped or sloped surface of the protrusion 30. In some embodiments, the movement or travel of the resilient member 15 in the receiving void 26 is 2.7 mm between the home position and the use position, as depicted by the arrow A2 in FIG. 3D. This is non-limiting and this distance may be tuned or otherwise customized to any distance. As such, the movement of the resilient member 15 between the home position and the use position may be greater than 2.7 mm or less than 2.7 mm.

In the depicted aspect, portions of the resilient member 15, in the use position, may remain in contact with the engagement surface 66 of the housing due to at least the acute angle portion 95b of the first intermediate portion 94 and/or portions of the third intermediate portion 98 having a specific size and shape to remain extended beyond the interior surface 24b of the pedal arm 16, as best illustrated in FIG. 10. This is not limiting and in other aspects, in the use position, portions of the resilient member 15 may be fully received within the receiving void 26 of the pedal arm 16.

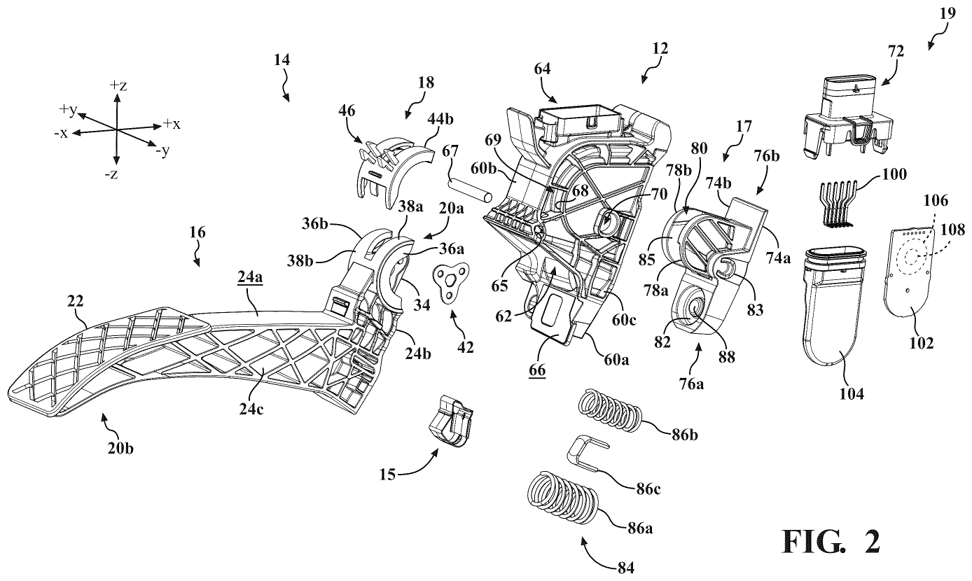

Now referring to FIG. 4, a graphical representation of a kickdown force behavior is schematically depicted. As depicted, a travel distance of the pedal arm in depicted as the abscissa and a force feedback felt by the driver is depicted as the ordinate. The target or desired force feedback curve is depicted as a dashed line. The curve 402 depicts that the resilient member 15 (FIG. 2) generally follows the desired curve and illustrates that the tuning caused by the geometric shape of the resilient member 15 and of the interior surface 28 with the protrusion 30 of the pedal arm provides a desirable force profile in the drop zone. As such the graphical representation illustrates that the change in the overlap length by the distal portion 90 moving relative to the proximate portion 92 and the movement of the resilient member 15 in the receiving void 26 tunes the kickdown drop along the desired curve while preventing the rapidly changing and sharp effects in conventional kickdown devices depicted by the curve 404.

Referring now back to FIG. 2, the sensor assembly 19 includes a connector assembly 72, a plurality of terminals 100, a circuit board 102, and an overmold cover 104. The connector assembly 72 is configured to extend from the housing 12 through the connector opening 64. The connector assembly 72 may house at least portions of the plurality of terminals 100. The circuit board 102 may be encapsulated by the overmold cover 104 as well as at least portions of the plurality of terminals 100. The sensor assembly 19 communicatively connects the example pedal assembly 10 to other components of a vehicle such as an electronic control module and/or a powertrain controller. The circuit board 102 may be a printed circuit board. In embodiments, the circuit board 102 may include at least one receiver coil 106 and a transmitter coil 108.

The coupler 42 may be mounted or attached to the hub portion 20a of the pedal arm 16 in the vicinity of and perpendicular to an axis of movement of the pedal arm 16. As such, the coupler 42 may be positioned adjacent to the at least one receiver coil 106. In some embodiments, the coupler 42 may include distinct lobes, such as three lobes as best illustrated in FIG. 2. The coupler 42 may rotate or pivot upon movement of the hub portion 20a of the pedal arm 16.

The at least one receiver coil 106 and the transmitter coil 108 detect the movements of the coupler 42 and that data may be transmitted to an ECU and/or powertrain controller communicatively coupled to the sensor assembly 19 via the connector assembly 72 of the sensor assembly 19.

Now referring back to FIGS. 5A-9, the assembly operation of the example ETC pedal assembly 10 is schematically depicted. The example ETC pedal assembly 10 is configured to be assembled from an unassembled sate into an assembled state using less components and in A more efficient manner and more desirable manufacturing costs and time than that of conventional ETC pedal assemblies. As depicted in FIGS. 5A-5C, the pedal arm assembly 14 is assembled by aligning the bearing member 18 with the pair of flanges 36a, 36b of the hub portion and rotating the bearing member 18 in the direction of arrow A3 depicted in FIG. 5C to rotatably lock the bearing member 18 onto the hub portion 20a of the pedal arm 16. The resilient member 15 may be inserted into the receiving void 26 and the pedal arm assembly 14, now assembled, is inserted into the opening 62 of the housing 12.

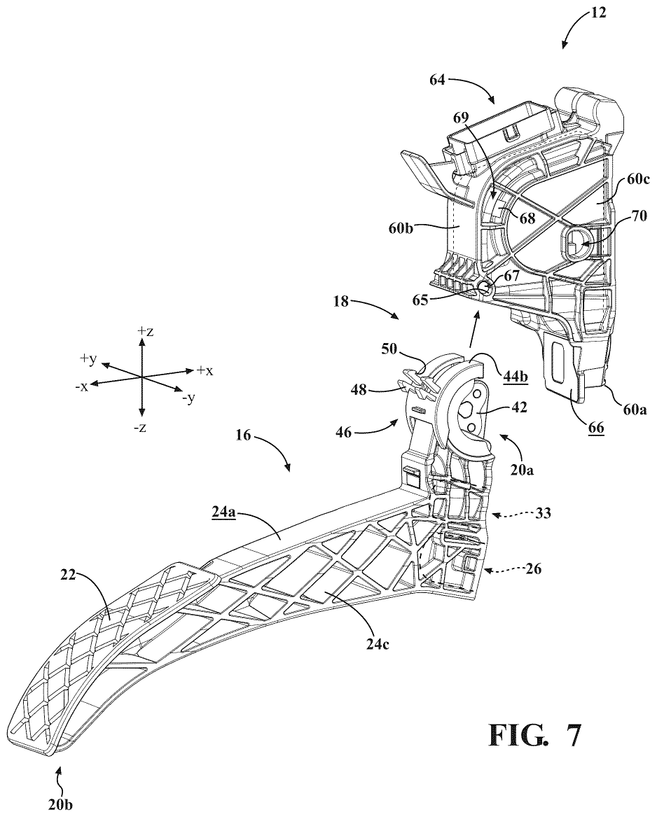

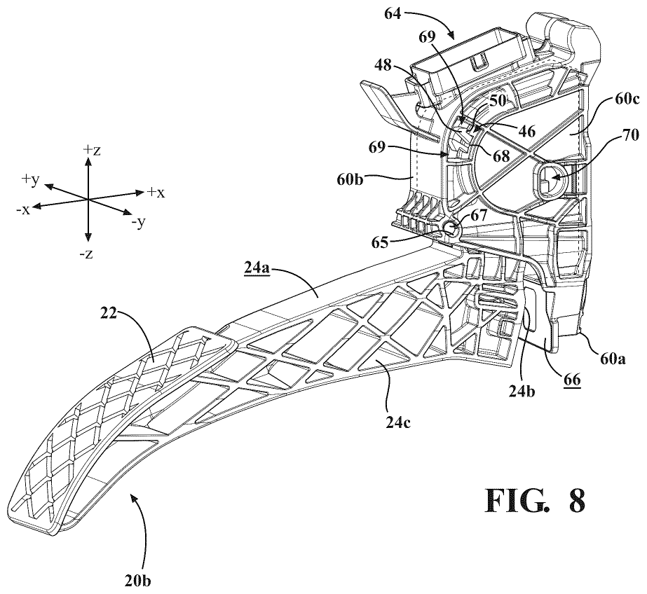

The at least one resilient member 46 of the bearing member 18 is inserted into the corresponding at least one slot 68 of the housing, thereby coupling the pedal arm assembly 14 to the housing 12, as best illustrated in FIGS. 7-8. A portion of the compressible member 84 is inserted into the compressible member receiving cavity 33 through the opening 62 of the housing 12 from the rear. The compressible member 84 may be inserted independently or along with the carrier 17. The carrier 17 is attached to the housing via the pair of protrusions 83 extending therefrom and received into the corresponding receiving aperture 70 of the housing 12 in a snap fit arrangement and may permit for movement of the carrier 17 with respect to the housing 12. As such, the outer surface 74a of the carrier 17 encloses the opening 62 from the rear of the housing 12. That is, the carrier 17 may form part of the back wall 60a of the housing 12.

Now referring to FIGS. 11A-11B, a second aspect of the example ETC pedal assembly 10′ is schematically depicted. It is understood that the example ETC pedal assembly 10′ is similar to the example ETC pedal assembly 10 with the exceptions of the features described herein. As such, like features will use the same reference numerals with a suffix “′” for the reference numbers. As such, for brevity reasons, these features will not be described again.

As depicted, the carrier 17′ in this aspect now includes a protrusions 1102 extending from the inner surface 74b′ of the carrier 17′. The protrusion 1102 extends from the inner surface 74b′ a distance to allow the carrier 17′ and the compressible member 84′ to couple to the housing 12 (FIG. 1) and the pedal arm 16′ as discussed above. The protrusion 1102 includes a terminating end 1104, opposite of the inner surface 74b′, which may be curved or rounded (e.g., curvilinear) in a semicircular shape. Portions of the terminating end 1104 include a contact surface 1106 that is configured to slidably engage with the hub portion 20a′ of the pedal arm 16′, as discussed in greater detail herein. As such, the contact surface 1106 may also be curved or rounded and may have a smooth contour. In some embodiments, the contact surface 1106 may be coupled to or otherwise attached to at least a portion of the terminating end 1104 of the protrusion 1102. In other embodiments, the contact surface 1106 may be monolithically formed with the protrusion 1102 as a single, unitary price.

The hub portion 20a′ of the pedal arm 16′ includes a cavity 1108 that is configured to receive at least a portion of the protrusion 1102. The cavity 1108 may be defined by an inner surface 1110 that is configured to slidably engage with the contact surface 1106 of the terminating end 1104 of the protrusion 1102. As such, as the pedal arm 16′ moves, the movement causes the hub portion 20a to move with respect to the carrier 17′. Such a movement generates, or assists in generating, the force feedback by the friction caused by using the inner surface 1110 as a bearing surface against the contact surface 1106 of the protrusion 1102 of the carrier 17′. As such, it should be understood that the contact surface 1106 may be adjusted by thickness, width, and the like, to customize or otherwise tune the force feedback felt by the driver at the pedal pad portion 20b.

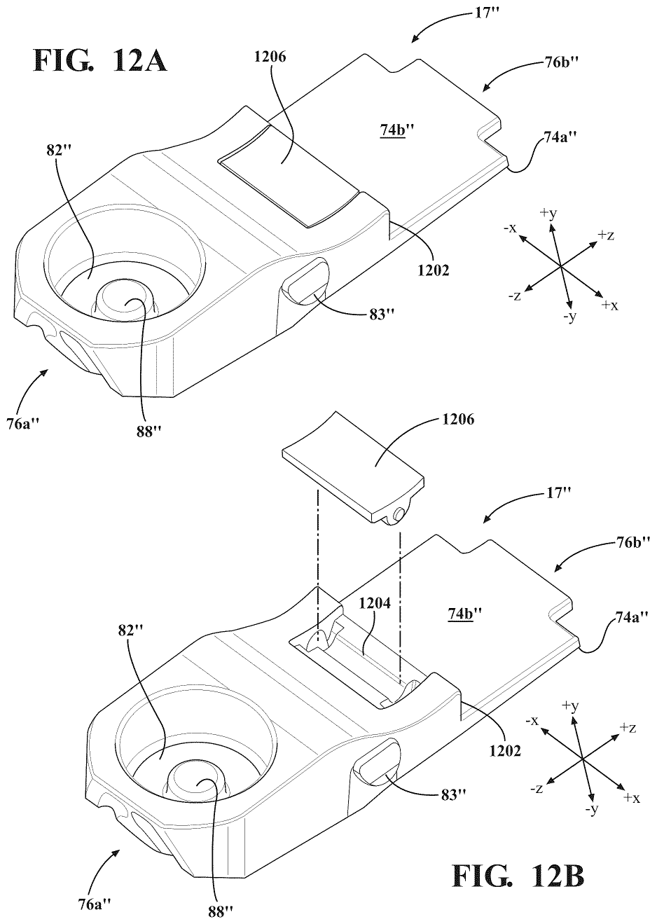

Now referring to FIGS. 12A-12B, a third aspect of a carrier 17″ is schematically depicted. It is understood that the carrier 17″ is similar to the carrier 17 and all other components of the example ETC pedal assembly 10 with the exceptions of the features described herein. As such, like features will use the same reference numerals with a suffix for the reference numbers. As such, for brevity reasons, these features will not be described again.

As depicted, inner surface 74b″ of the carrier 17″ in this aspect now includes a step 1202 in the vertical direction (e.g., in the +/−Z direction) and a receiving portion 1204 configured to receive a friction member 1206. The front portion 76a″ may have a planar contour and the friction member 1206 may be positioned to abut against a portion of the pedal arm 16 (FIG. 1) such that as the pedal arm 16 moves, loads between carrier 17″ pushes or drives the friction member 1206 against a portion of the pedal arm 16 to generate or create friction. The friction resists the motion and creates the mechanical hysteresis of force feedback.

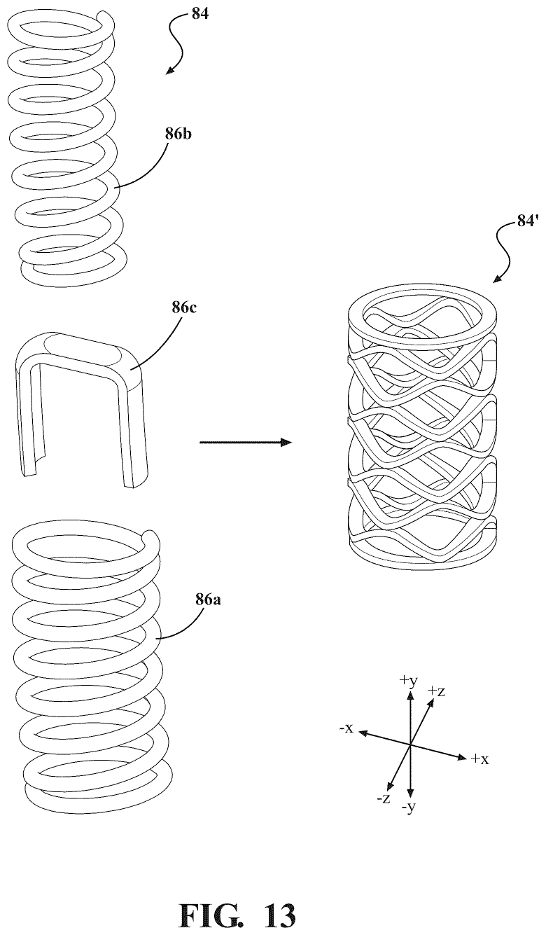

Now referring to FIG. 13, a second aspect of a compressible member 84′″ is schematically depicted. It is understood that the other components of the example ETC pedal assembly 10 remain the same with the exceptions of the features described herein. As such, like features will use the same reference numerals with a suffix “″′” for the reference numbers. As such, for brevity reasons, these features will not be described again.

As depicted, the outer compressible member 86a, such as a spring, the inner compressible member 86b, such as a spring received within an inner diameter of the outer compressible member 86a, and the damper 86c are replaced with compressible member 84′″ that has a wave shape arrangement. The compressible member 84′″ is sized and shaped to simply switch with the compressible member 84 (FIG. 2) to be received by and extending between the carrier 17 and the pedal arm 16 depicted in FIG. 10.

The compressible member 84′″ may be formed with stainless steel, wire, carbon steel, alloy steel, elgiloy, Monel®, copper, nickel, and/or the like. This is not limiting and the compressible member 84′″ may be any deformable material or design, such as elastomer. The properties of the compressible member 84′″ compared to the outer compressible member 86a and the inner compressible member 86b are illustrated below in Table 1.

In particular, L₀ is an overall length in mm when no force is applied, R (Spring Rate/Constant) is a force required to compress or extend the compressible member by a specific distance (N/mm), L₁ and L₂ (Loaded Lengths) is the compressible member's length when subjected to specific forces; L₁ is the “installed” or “working” length, while L₂ is a further compressed or extended length, F₁ and F₂ (Loads/Forces) is the force (Newtons) required to achieve lengths L₁ and L₂, respectively.

TABLE 1

| | Outer | Inner | compressible |
|---|---|---|---|
| | compressible | compressible | member |
| | member 86a | member 86b | 84″′ |
| Lₒ | 48 | 46.5 | 94.5 |
| R | 3.9 | 3.3 | 7.2 |
| L₁ | 33.709 | 33.709 | 33.709 |
| F₁ | 55.73 | 42.21 | 97.95 |
| L₂ | 25.32 | 25.32 | 50.65 |
| F₂ | 88.4 | 69.9 | 158.3 |
| Dia. Max. (mm) | 18.65 | 13.45 | 18.6 |
| Dia. Min. (mm) | 14.85 | 10.35 | N/A |
| Wire Ø (mm) | 1.9 | 1.55 | N/A |

As such, Table 1 indicates that the parameters Lₒ, L₁, and L₂ may be modified. The working area proportion between L₁/F₁ to L₂/F₂ remains the same indicated by Equation 1 below.

Further, the diameter of the compressible member may be adjusted within the limitation of Dia max.

$$R = \frac{{F}_{2} - {F}_{1}}{{L}_{2} - {L}_{1}} \qquad Equation 1$$

As such, the outer diameter of the compressible member 84′″ needs to only be large enough to fit within the receiving cavity 33 of the pedal arm 16. The inner diameter can be any diameter to adjust the properties of the compressible member 84′″ as with the wire diameter or shape.

Thus, disclosed herein is an electronic throttle control (ETC) pedal assembly configured to provide a kick-down feeling to a driver's foot by utilizing a resilient member that is simpler, less expensive, requires less tooling and costs of manufacturing, and eliminates the double click effect compared to conventional kick-down devices. Further, the ETC pedal assembly disclosed herein provides for easier assembly process and less components compared to conventional assemblies, . . . . The arrangement od the ETC pedal assembly described herein may utilize the resilient member and the compressible member to generate the force feedback based on transforming certain components into cam surfaces and friction generating surfaces.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

ASPECTS LISTING:
Aspect 1: A pedal assembly comprising: a housing having an opening, a pedal arm having a hub portion at one end positioned within the opening of the housing and a pedal pad portion positioned on an opposite end of the pedal arm, the hub portion movably coupled to the housing, the pedal arm further having a receiving void positioned between the hub portion and the pedal pad portion, and a resilient member positioned at least partially within the receiving void, the resilient member having a distal portion and a proximate portion, the distal portion overlaps the proximate portion by an overlap length, the resilient member movable between a home position and a use position, wherein when a predetermined load is applied to the pedal pad portion, the resilient member is moved into the use position such that the overlap length of the distal portion with respect to the proximate portion is greater that the overlap length of the distal portion with respect to the proximate portion in the home position to generate a force feedback onto the pedal pad portion.
Aspect 2: The pedal assembly of Aspect 1, wherein the resilient member further comprises: a first intermediate portion extending from the distal portion, a second intermediate portion extending from the proximate portion, and a third intermediate portion positioned between and extending from the first intermediate portion and the second intermediate portion.
Aspect 3: The pedal assembly of any of Aspect 1 to Aspect 2, wherein the first intermediate portion is defined by pair of acute angle portions, one of the pair of acute angle portions in communication with the distal portion and the other one of the pair of acute angle portions in communication with the third intermediate portion, the one of the pair of acute angle portions in communication with the distal portion having a greater angle than the other one of the pair of acute angle portions in communication with the third intermediate portion.
Aspect 4: The pedal assembly of any of Aspect 2 to Aspect 3, wherein the second intermediate portion is defined by a concave portion and an acute angle portion, the concave portion in communication with the proximate portion and the acute angle portion, and the acute angle portion in communication with the third intermediate portion.
Aspect 5: The pedal assembly of any of Aspect 2 to Aspect 4, wherein a portion of the first intermediate portion or a portion of the third intermediate portion are configured to engage with a portion of the housing based on an amount of the predetermined load applied to the pedal pad portion.
Aspect 6: The pedal assembly of any of Aspect 2 to Aspect 5, wherein the receiving void further comprises: a protrusion having a ramped sloped surface configured to engage with at least a portion of the resilient member.
Aspect 7: The pedal assembly of any of Aspect 2 to Aspect 6, wherein when the portion of the first intermediate portion or the portion of the second intermediate portion engage with the portion of the housing, the resilient member is displaced within the receiving void thereby permitting portions of the resilient member to move within the receiving void against the ramped sloped surface of the protrusion causing the overlap length of the distal portion with respect to the proximate portion to greater that the overlap length of the distal portion with respect to the proximate portion in the home position thereby generating the force feedback onto the pedal pad portion.
Aspect 8: The pedal assembly of any of Aspect 1 to Aspect 7, further comprising: a bearing member having a pair of receiving grooves, and wherein the hub portion includes a pair of flanges that complement the pair of receiving grooves such that the bearing member is positioned coupled to the hub portion via an engagement between the pair of flanges and the pair of receiving grooves.
Aspect 9: The pedal assembly of any of Aspect 1 to Aspect 8, wherein: the pair of receiving grooves are spaced apart and each positioned on an interior surface of the bearing member, each of the pair of receiving grooves are arcuate in shape to match an arcuate shape of each of the pair of flanges, and at least one resilient member extends from an exterior surface of the bearing member.
Aspect 10: The pedal assembly of any of Aspect 1 to Aspect 9, wherein the at least one resilient member is configured to engage with a portion of the housing to movably couple the hub portion of the pedal arm to the housing.
Aspect 11: The pedal assembly of any of Aspect 1 to Aspect 10, further comprising: a carrier coupled to and received within the opening of the housing to enclose a portion of the opening, at least one compressible member positioned extend between and to be in contact with the pedal arm and the carrier, wherein when the predetermined load is applied to the pedal pad portion, the at least one compressible member is compressed to provide an increased force to the pedal arm generating additional force between the hub portion and the interior surface of the bearing member thereby generating an additional force feedback onto the pedal pad portion.
Aspect 12: The pedal assembly of any of Aspect 1 to Aspect 11, wherein the carrier further comprises: a pair of spaced apart ears extending from an inner surface to define a gap, portions of the hub portion are received within the gap such that when the predetermined load is applied to the pedal pad portion, the at least one compressible member and the pair of spaced apart ears provide the increased force to the pedal arm generating additional force between the hub portion and the interior surface of the bearing member thereby generating the additional force feedback onto the pedal pad portion.
Aspect 13: The pedal assembly of any of Aspect 1 to Aspect 12, wherein: the hub portion of the pedal arm further includes a pedal arm cavity defined by an interior surface, and the carrier further comprises: a protrusion extending from an inner surface, portions of the protrusion are received within the pedal arm cavity and a surface of the protrusion is configured to movably engage with portions of the interior surface of the pedal arm cavity such that when the predetermined load is applied to the pedal pad portion, the at least one compressible member and the surface of the protrusion interacts with the interior surface of the pedal arm cavity to provide the increased force to the pedal arm generating the additional force feedback onto the pedal pad portion.
Aspect 14: A pedal assembly comprising: a housing having an opening, a pedal arm having a hub portion at one end positioned within the opening of the housing and a pedal pad portion positioned on an opposite end of the pedal arm, the hub portion including a pair of flanges, the pedal arm further having a receiving void positioned between the hub portion and the pedal pad portion, a bearing member having an interior surface, an opposite exterior surface, a pair of receiving grooves, and at least one resilient member extending from the exterior surface, the pair of receiving grooves positioned to complement the pair of flanges such that the bearing member is positioned to couple to the hub portion via a slidably engagement between the pair of flanges and the pair of receiving grooves, the at least one resilient member is configured to engage with a portion of the housing to movably couple the hub portion of the pedal arm to the housing, a carrier coupled to and received within the opening of the housing to enclose a portion of the opening, at least one compressible member positioned extend between and to be in contact with the pedal arm and the carrier, and a resilient member positioned at least partially within the receiving void, the resilient member having a distal portion and a proximate portion, the distal portion overlaps the proximate portion by an overlap length, the resilient member movable between a home position and a use position, wherein when a predetermined load is applied to the pedal pad portion, the resilient member is moved into the use position such that the overlap length of the distal portion with respect to the proximate portion is greater that the overlap length of the distal portion with respect to the proximate portion in the home position and the at least one compressible member is compressed to provide an increased force to the pedal arm generating additional force between the hub portion and the interior surface of the bearing member thereby together generating a force feedback onto the pedal pad portion.
Aspect 15: The pedal assembly of Aspect 14, wherein the resilient member further comprises: a first intermediate portion extending from the distal portion, a second intermediate portion extending from the proximate portion, and a third intermediate portion positioned between and extending from the first intermediate portion and the second intermediate portion.
Aspect 16: The pedal assembly of any of Aspect 14 to Aspect 15, wherein: the first intermediate portion is defined by pair of acute angle portions, one of the pair of acute angle portions in communication with the distal portion and the other one of the pair of acute angle portions in communication with the third intermediate portion, the one of the pair of acute angle portions in communication with the distal portion having a greater angle than the other one of the pair of acute angle portions in communication with the third intermediate portion, and the second intermediate portion is defined by a concave portion and an acute angle portion, the concave portion in communication with the proximate portion and the acute angle portion, and the acute angle portion in communication with the third intermediate portion, wherein a portion of the first intermediate portion or a portion of the second intermediate portion are configured to engage with a portion of the housing based on an amount of the predetermined load applied to the pedal pad portion.
Aspect 17: The pedal assembly of any of Aspect 14 to Aspect 16, wherein the receiving void further comprises: a protrusion having a ramped sloped surface configured to engage with at least a portion of the resilient member.
Aspect 18: The pedal assembly of any of Aspect 14 to Aspect 17, wherein when the portion of the first intermediate portion or the portion of the second intermediate portion engage with the portion of the housing, the resilient member is displaced within the receiving void thereby permitting portions of the resilient member to move within the receiving void against the ramped sloped surface of the protrusion causing the overlap length of the distal portion with respect to the proximate portion to greater that the overlap length of the distal portion with respect to the proximate portion in the home position thereby generating the force feedback onto the pedal pad portion.
Aspect 19: The pedal assembly of any of Aspect 14 to Aspect 18, wherein the carrier further comprises: a pair of spaced apart ears extending from an inner surface to define a gap, portions of the hub portion are received within the gap such that when the predetermined load is applied to the pedal pad portion, the at least one compressible member and the pair of spaced apart ears provide the increased force to the pedal arm generating additional force between the hub portion and the interior surface of the bearing member thereby generating an additional force feedback onto the pedal pad portion.
Aspect 20: The pedal assembly of any of Aspect 14 to Aspect 19, wherein: the hub portion of the pedal arm further includes a pedal arm cavity defined by an interior surface, and the carrier further comprises: a protrusion extending from an inner surface, portions of the protrusion are received within the pedal arm cavity and a surface thereof is configured to movably engage with portions of the interior surface of the pedal arm cavity such that when the predetermined load is applied to the pedal pad portion, the at least one compressible member and the surface of the protrusion interacts with the interior surface to provide the increased force to the pedal arm generating an additional force feedback onto the pedal pad portion.

What is claimed is:

1. A pedal assembly comprising:
a housing having an opening;
a pedal arm having a hub portion at one end positioned within the opening of the housing and a pedal pad portion positioned on an opposite end of the pedal arm, the hub portion movably coupled to the housing, the pedal arm further having a receiving void positioned between the hub portion and the pedal pad portion, and
a resilient member positioned at least partially within the receiving void, the resilient member having a distal portion and a proximate portion, the distal portion overlaps the proximate portion by an overlap length, the resilient member movable between a home position and a use position,
wherein when a predetermined load is applied to the pedal pad portion, the resilient member is moved into the use position such that the overlap length of the distal portion with respect to the proximate portion is greater that the overlap length of the distal portion with respect to the proximate portion in the home position to generate a force feedback onto the pedal pad portion.

2. The pedal assembly of claim 1, wherein the resilient member further comprises:
a first intermediate portion extending from the distal portion;
a second intermediate portion extending from the proximate portion; and
a third intermediate portion positioned between and extending from the first intermediate portion and the second intermediate portion.

3. The pedal assembly of claim 2, wherein the first intermediate portion is defined by pair of acute angle portions, one of the pair of acute angle portions in communication with the distal portion and the other one of the pair of acute angle portions in communication with the third intermediate portion, the one of the pair of acute angle portions in communication with the distal portion having a greater angle than the other one of the pair of acute angle portions in communication with the third intermediate portion.

4. The pedal assembly of claim 3, wherein the second intermediate portion is defined by a concave portion and an acute angle portion, the concave portion in communication with the proximate portion and the acute angle portion, and the acute angle portion in communication with the third intermediate portion.

5. The pedal assembly of claim 2, wherein a portion of the first intermediate portion or a portion of the third intermediate portion are configured to engage with a portion of the housing based on an amount of the predetermined load applied to the pedal pad portion.

6. The pedal assembly of claim 5, wherein the receiving void further comprises:
a protrusion having a ramped sloped surface configured to engage with at least a portion of the resilient member.

7. The pedal assembly of claim 6, wherein when the portion of the first intermediate portion or the portion of the second intermediate portion engage with the portion of the housing, the resilient member is displaced within the receiving void thereby permitting portions of the resilient member to move within the receiving void against the ramped sloped surface of the protrusion causing the overlap length of the distal portion with respect to the proximate portion to greater that the overlap length of the distal portion with respect to the proximate portion in the home position thereby generating the force feedback onto the pedal pad portion.

8. The pedal assembly of claim 1, further comprising:
a bearing member having a pair of receiving grooves, and
wherein the hub portion includes a pair of flanges that complement the pair of receiving grooves such that the bearing member is positioned coupled to the hub portion via an engagement between the pair of flanges and the pair of receiving grooves.

9. The pedal assembly of claim 8, wherein:
the pair of receiving grooves are spaced apart and each positioned on an interior surface of the bearing member;
each of the pair of receiving grooves are arcuate in shape to match an arcuate shape of each of the pair of flanges; and
at least one resilient member extends from an exterior surface of the bearing member.

10. The pedal assembly of claim 9, wherein the at least one resilient member is configured to engage with a portion of the housing to movably couple the hub portion of the pedal arm to the housing.

11. The pedal assembly of claim 9, further comprising:
a carrier coupled to and received within the opening of the housing to enclose a portion of the opening;
at least one compressible member positioned extend between and to be in contact with the pedal arm and the carrier,
wherein when the predetermined load is applied to the pedal pad portion, the at least one compressible member is compressed to provide an increased force to the pedal arm generating additional force between the hub portion and the interior surface of the bearing member thereby generating an additional force feedback onto the pedal pad portion.

12. The pedal assembly of claim 11, wherein the carrier further comprises:
a pair of spaced apart ears extending from an inner surface to define a gap, portions of the hub portion are received within the gap such that when the predetermined load is applied to the pedal pad portion, the at least one compressible member and the pair of spaced apart ears provide the increased force to the pedal arm generating additional force between the hub portion and the interior surface of the bearing member thereby generating the additional force feedback onto the pedal pad portion.

13. The pedal assembly of claim 11, wherein:
the hub portion of the pedal arm further includes a pedal arm cavity defined by an interior surface, and
the carrier further comprises:
a protrusion extending from an inner surface, portions of the protrusion are received within the pedal arm cavity and a surface of the protrusion is configured to movably engage with portions of the interior surface of the pedal arm cavity such that when the predetermined load is applied to the pedal pad portion, the at least one compressible member and the surface of the protrusion interacts with the interior surface of the pedal arm cavity to provide the increased force to the pedal arm generating the additional force feedback onto the pedal pad portion.

14. A pedal assembly comprising:
a housing having an opening;
a pedal arm having a hub portion at one end positioned within the opening of the housing and a pedal pad portion positioned on an opposite end of the pedal arm, the hub portion including a pair of flanges, the pedal arm further having a receiving void positioned between the hub portion and the pedal pad portion;
a bearing member having an interior surface, an opposite exterior surface, a pair of receiving grooves, and at least one resilient member extending from the exterior surface, the pair of receiving grooves positioned to complement the pair of flanges such that the bearing member is positioned to couple to the hub portion via a slidably engagement between the pair of flanges and the pair of receiving grooves, the at least one resilient member is configured to engage with a portion of the housing to movably couple the hub portion of the pedal arm to the housing;
a carrier coupled to and received within the opening of the housing to enclose a portion of the opening;
at least one compressible member positioned extend between and to be in contact with the pedal arm and the carrier; and
a resilient member positioned at least partially within the receiving void, the resilient member having a distal portion and a proximate portion, the distal portion overlaps the proximate portion by an overlap length, the resilient member movable between a home position and a use position,
wherein when a predetermined load is applied to the pedal pad portion, the resilient member is moved into the use position such that the overlap length of the distal portion with respect to the proximate portion is greater that the overlap length of the distal portion with respect to the proximate portion in the home position and the at least one compressible member is compressed to provide an increased force to the pedal arm generating additional force between the hub portion and the interior surface of the bearing member thereby together generating a force feedback onto the pedal pad portion.

15. The pedal assembly of claim 14, wherein the resilient member further comprises:
a first intermediate portion extending from the distal portion;
a second intermediate portion extending from the proximate portion; and
a third intermediate portion positioned between and extending from the first intermediate portion and the second intermediate portion.

16. The pedal assembly of claim 15, wherein:
the first intermediate portion is defined by pair of acute angle portions, one of the pair of acute angle portions in communication with the distal portion and the other one of the pair of acute angle portions in communication with the third intermediate portion, the one of the pair of acute angle portions in communication with the distal portion having a greater angle than the other one of the pair of acute angle portions in communication with the third intermediate portion; and
the second intermediate portion is defined by a concave portion and an acute angle portion, the concave portion in communication with the proximate portion and the acute angle portion, and the acute angle portion in communication with the third intermediate portion,
wherein a portion of the first intermediate portion or a portion of the second intermediate portion are configured to engage with a portion of the housing based on an amount of the predetermined load applied to the pedal pad portion.

17. The pedal assembly of claim 16, wherein the receiving void further comprises:
a protrusion having a ramped sloped surface configured to engage with at least a portion of the resilient member.

18. The pedal assembly of claim 17, wherein when the portion of the first intermediate portion or the portion of the second intermediate portion engage with the portion of the housing, the resilient member is displaced within the receiving void thereby permitting portions of the resilient member to move within the receiving void against the ramped sloped surface of the protrusion causing the overlap length of the distal portion with respect to the proximate portion to greater that the overlap length of the distal portion with respect to the proximate portion in the home position thereby generating the force feedback onto the pedal pad portion.

19. The pedal assembly of claim 14, wherein the carrier further comprises:
a pair of spaced apart ears extending from an inner surface to define a gap, portions of the hub portion are received within the gap such that when the predetermined load is applied to the pedal pad portion, the at least one compressible member and the pair of spaced apart ears provide the increased force to the pedal arm generating additional force between the hub portion and the interior surface of the bearing member thereby generating an additional force feedback onto the pedal pad portion.

20. The pedal assembly of claim 14, wherein:
the hub portion of the pedal arm further includes a pedal arm cavity defined by an interior surface, and
the carrier further comprises:
a protrusion extending from an inner surface, portions of the protrusion are received within the pedal arm cavity and a surface thereof is configured to movably engage with portions of the interior surface of the pedal arm cavity such that when the predetermined load is applied to the pedal pad portion, the at least one compressible member and the surface of the protrusion interacts with the interior surface to provide the increased force to the pedal arm generating an additional force feedback onto the pedal pad portion.
